(19) United States
(12) Patent Application Publication
(10) Pub. No.: US 2025/0277959 A1
(43) Pub. Date: Sep. 4, 2025

(54) OPTICAL LENS ASSEMBLY AND OPTICAL MODULE

(71) Applicant: Newmax Technology Co., Ltd., Taichung City (TW)

(72) Inventors: Chun-Sheng LEE, Taichung City (TW); Ching-Yun HUANG, Taichung City (TW)

(21) Appl. No.: 18/642,311

(22) Filed: Apr. 22, 2024

(30) Foreign Application Priority Data
Feb. 29, 2024 (TW) 113107213

(51) Int. Cl. G02B 9/10

(52) U.S. Cl. CPC G02B 9/10

(57) ABSTRACT

An optical lens assembly includes a stop, and includes, in order from an image side to an image source side: a first lens with positive refractive power; and a second lens with positive refractive power; wherein a total quantity of lenses with refractive power in the optical lens assembly is two, a focal length of the first lens element is f1, an entrance pupil diameter of the optical lens assembly is EPD, a maximum image source height of the optical lens assembly is IMH, and the following condition is satisfied: 4.94(mm⁻¹)<f1/(EPD*IMH)<13.57(mm⁻¹).

### CROSS-REFERENCE TO RELATED APPLICATION

This application claims the benefit of Taiwan Patent Application No. 113107213, filed on Feb. 29, 2024, which is hereby incorporated by reference for all purposes as if fully set forth herein.

### BACKGROUND

### Technical Field

The present disclosure relates to an optical lens assembly and an optical module, and in particular, to an optical lens assembly and an optical module applicable to an electronic device.

### Related Art

Today's digital imaging technology continues to innovate and change, especially in the electronic carriers of notebook computers, tablets, and mobile phones, which are all developing towards miniaturization. Photosensitive elements such as CCD or CMOS are also required to be smaller. According to the infrared focusing lens applications, it is not only used in the field of photography, in recent years but also it has been widely used in the field of infrared reception and infrared sensing of the electronic carriers such as notebook computers, tablets, and mobile phones.

The current electronic carrier mainly uses 3D applications that are more three-dimensional, realistic and immersive. However, the current 3D projection angle (viewing angle) of the electronic carrier is larger, the number of lenses of the electronic carrier is more, and the electronic carrier is unable to meet the requirements of an optical lens assembly with few lenses, high performance and small viewing angle.

### SUMMARY

An objective of the present disclosure is to resolve the above problems of the prior art. In order to achieve the above objective, the present disclosure provides an optical lens assembly comprising a stop, and in order from an image side to an image source side, comprising: a first lens with positive refractive power, comprising an image-side surface and an image-source-side surface, wherein the image-side surface of the first lens is concave near the optical axis; and a second lens with positive refractive power, comprising an image-side surface and an image-source-side surface, wherein the image-source-side surface of the second lens is convex near the optical axis.

A total quantity of lenses with refractive power in the optical lens assembly is two. An entrance pupil diameter of the optical lens assembly is EPD, a maximum image source height of the optical lens assembly is IMH, a curvature radius of an image-side surface of the first lens is R1, a curvature radius of an image-side surface of the second lens is R3, a curvature radius of an image-source-side surface of the second lens is R4, a focal length of the optical lens assembly is f, a focal length of the first lens is f1, a focal length of the second lens is f2, a distance from the image-source-side surface of the first lens to the image-side surface of the second lens along the optical axis is T12, a central thickness of the second lens along the optical axis is CT2, a maximum optical effective radius of an image-side surface of the first lens is CA1, a maximum optical effective radius of an image-source-side surface of the second lens is CA4, an incident angle where a chief ray is incident on the image plane at a maximum view angle of the optical lens assembly is CRA, a maximum field of view of the optical lens assembly is FOV, helf of a maximum field of view of the optical lens assembly is HFOV, a distance from an image-side surface of the first lens to an image source plane along the optical axis is TL, a distance from the image-source-side surface of the second lens to the image source plane along the optical axis is BFL, a distance from the stop to an image source plane along the optical axis is SL, a central thickness of the first lens along the optical axis is CT1, a central thickness of the second lens along the optical axis is CT2, a distance in parallel with the optical axis from an axial point on the image-side surface of the first lens to a maximum optical effective radius position of the image-side surface of the first lens is TDP1, a distance in parallel with the optical axis from an axial point on an image-source-side surface of the second lens to a maximum optical effective radius position of the image-source-side surface of the second lens is TDP4, and at least one condition is satisfied as follows:

$$4.94 ( {mm}^{- 1} ) < f 1 / ( EPD * IMH ) < 13.57 ( {mm}^{- 1} ) ; \\ - 12.22 < R 3 / R 4 < 43.78 ; \\ - 0. 34 < ( f / f 1 ) - ( f / f 2 ) < - 0.01 ;$$

$$1.02 < CT 2 / T 12 < 21 .02 ;$$

$$1.96 ( 1 {/}^{∘} ) < ( CA 4 / IMH ) / CRA < 231.05 ( 1 {/}^{°} ) ;$$

$$73.82 < FOV / CRA < 7215 .33 ; \\ - 42.35 < R 3 / f < 13 .48 ;$$

$$4199 {(}^{°} ) < HFOV * ( CA 4 / CA 1 ) < 79.54 {(}^{∘} ) ;$$

$$1.91 < TL / BFL < 4.60 ;$$

$$0.77 ( mm {/}^{°} ) < EPD / CRA < 75.60 ( mm {/}^{°} ) ;$$

$$1.93 < TL / f < 3 .12 ;$$

$$2.05 < SL / f < 3.27 ; \\ - 1.73 ( {mm}^{- 1} ) < 1 / R 1 < - 0.89 ( {mm}^{- 1} ) ;$$

$$1.12 < ( CT 2 / CT 1 ) * ( TDP 4 / TDP 1 ) < 6.19 .$$

When the optical lens assembly satisfies the conditions of 4.94(mm⁻¹)<f1/(EPD*NIH)<13.57(mm⁻¹), by using the appropriate configuration of the focal length of the first lens, the entrance pupil diameter and the maximum image source height, the optical lens assembly has a larger amount of incident light.

When the optical lens assembly satisfies the conditions of −12.22<R3/R4<43.78, the appropriate distribution of the curvature of the second lens is helpful to correct the aberration of the optical lens assembly to improve the image quality of the optical lens assembly.

When the optical lens assembly satisfies the conditions of −0.34<(f/f1)−(f/f2)<−0.01, the optical lens assembly has a smaller angle at which the chief ray of the maximum viewing angle is incident on the image source plane, and the image quality of the optical lens assembly can be improved.

When the optical lens assembly satisfies the conditions of 1.02<CT2/T12<21.02, this allows the optical lens assembly to have better formability, and allows a space to be adjusted according to the needs of the mechanism.

When the optical lens assembly satisfies the conditions of 1.96(1/°)<(CA4/IMH)/CRA<231.05(1/°), the optical lens assembly has a smaller angle at which the chief ray of the maximum viewing angle is incident on the image source plane.

When the optical lens assembly satisfies the conditions of 73.82<FOV/CRA<7215.33, the optical lens assembly has a smaller angle at which the chief ray of the maximum viewing angle is incident on the image source plane.

When the optical lens assembly satisfies the conditions of −42.35<R3/f<13.48, the appropriate distribution of the curvature of the second lens is beneficial to correcting the aberration of the optical lens assembly.

When the optical lens assembly satisfies the conditions of 41.99(°)<HFOV*(CA4/CA1)<79.54(°), by using this appropriate configuration, the optical lens assembly has a larger amount of incident light, thereby improving the image quality of the optical lens assembly.

When the optical lens assembly satisfies the conditions of 1.91<TL/BFL<4.60, in this way, a space can be adjusted according to the needs of the mechanism to avoid interference with the appearance of the mechanism, reduce assembly tolerances, and improve the quality of lens products.

When the optical lens assembly satisfies the conditions of 0.77(mm/°)<EPD/CRA<75.60(mm/°), by using this appropriate configuration, the optical lens assembly can have a larger amount of incident light and have a smaller angle at which the chief ray of the maximum viewing angle is incident on the image source plane.

When the optical lens assembly satisfies the conditions of 1.93<TL/f<3.12, in this way, the angle at which the chief ray of the maximum viewing angle is incident on the image source plane can be appropriately controlled.

When the optical lens assembly satisfies the conditions of 2.05<SL/f<3.27, the angle at which the chief ray of the maximum viewing angle is incident on the image source plane can be appropriately provided.

When the optical lens assembly satisfies the conditions of −1.73(mm⁻¹)<1/R1<−0.89(mm⁻¹), the appropriate distribution of the curvature of the first lens is beneficial to correcting the aberration of the optical lens assembly.

When the optical lens assembly satisfies the conditions of 1.12<(CT2/CT1)*(TDP4/TDP1)<6.19, in this way, the spatial adjustability of the optical lens assembly is improved, and lenses of the optical lens assembly have better formability.

In addition, the present disclosure further provides an optical module. The optical module comprises: a lens barrel; an optical lens assembly disposed in the lens barrel; and a light source disposed on an image source plane of the optical lens assembly.

The optical lens assembly comprising a stop, and in order from an image side to an image source side, comprising: a first lens with positive refractive power, comprising an image-side surface and an image-source-side surface, wherein the image-side surface of the first lens is concave near the optical axis; and a second lens with positive refractive power, comprising an image-side surface and an image-source-side surface, wherein the image-source-side surface of the second lens is convex near the optical axis.

A total quantity of lenses with refractive power in the optical lens assembly is two. An entrance pupil diameter of the optical lens assembly is EPD, a maximum image source height of the optical lens assembly is IMH, a curvature radius of an image-side surface of the first lens is R1, a curvature radius of an image-side surface of the second lens is R3, a curvature radius of an image-source-side surface of the second lens is R4, a focal length of the optical lens assembly is f, a focal length of the first lens is f1, a focal length of the second lens is f2, a distance from the image-source-side surface of the first lens to the image-side surface of the second lens along the optical axis is T12, a central thickness of the second lens along the optical axis is CT2, a maximum optical effective radius of an image-side surface of the first lens is CA1, a maximum optical effective radius of an image-source-side surface of the second lens is CA4, an incident angle where a chief ray is incident on the image plane at a maximum view angle of the optical lens assembly is CRA, a maximum field of view of the optical lens assembly is FOV, helf of a maximum field of view of the optical lens assembly is HFOV, a distance from an image-side surface of the first lens to an image source plane along the optical axis is TL, a distance from the image-source-side surface of the second lens to the image source plane along the optical axis is BFL, a distance from the stop to an image source plane along the optical axis is SL, a central thickness of the first lens along the optical axis is CT1, a central thickness of the second lens along the optical axis is CT2, a distance in parallel with the optical axis from an axial point on the image-side surface of the first lens to a maximum optical effective radius position of the image-side surface of the first lens is TDP1, a distance in parallel with the optical axis from an axial point on an image-source-side surface of the second lens to a maximum optical effective radius position of the image-source-side surface of the second lens is TDP4, and at least one condition is satisfied as follows:

$$4.94 ( {mm}^{- 1} ) < f 1 / ( EPD * IMH ) < 13.57 ( {mm}^{- 1} ) ; \\ - 12.22 < R 3 / R 4 < 43.78 ; \\ - 0.34 < ( f / f 1 ) - ( f / f 2 ) < - 0.01 ;$$

$$1.02 < CT 2 / T 12 < 21 .02 ;$$

$$1.96 ( 1 {/}^{°} ) < ( CA 4 / IMH ) / CRA < 231.05 ( 1 {/}^{∘} ) ;$$

$$73.82 < FOV / CRA < 7215 .33 ; \\ - 42.35 < R 3 / f < 13 .48 ;$$

$$41.99 {(}^{°} ) < HFOV * ( CA 4 / CA 1 ) < 79.54 {(}^{°} ) ;$$

$$1.91 < TL / BFL < 4.60 ;$$

$$0.77 ( mm {/}^{°} ) < EPD / CRA < 75.60 ( mm {/}^{∘} ) ;$$

$$1.93 < TL / f < 3 .12 ;$$

$$2.05 < SL / f < 3.27 ; \\ - 1.73 ( {mm}^{- 1} ) < 1 / R 1 < - 0.89 ( {mm}^{- 1} ) ;$$

$$1.12 < ( CT 2 / CT 1 ) * ( TDP 4 / TDP 1 ) < 6.19 .$$

When the optical lens assembly satisfies the conditions of 4.94(mm⁻¹)<f1/(EPD*IMH)<13.57(mm⁻¹), by using the appropriate configuration of the focal length of the first lens, the entrance pupil diameter and the maximum image source height, the optical lens assembly has a larger amount of incident light.

When the optical lens assembly satisfies the conditions of −12.22<R3/R4<43.78, the appropriate distribution of the curvature of the second lens is helpful to correct the aberration of the optical lens assembly to improve the image quality of the optical lens assembly.

When the optical lens assembly satisfies the conditions of −0.34<(f/f1)−(f/f2)<−0.01, the optical lens assembly has a smaller angle at which the chief ray of the maximum viewing angle is incident on the image source plane, and the image quality of the optical lens assembly can be improved.

When the optical lens assembly satisfies the conditions of 1.02<CT2/T12<21.02, this allows the optical lens assembly to have better formability, and allows a space to be adjusted according to the needs of the mechanism.

When the optical lens assembly satisfies the conditions of 1.96(1/°)<(CA4/IMH)/CRA<231.05(1/°), the optical lens assembly has a smaller angle at which the chief ray of the maximum viewing angle is incident on the image source plane.

When the optical lens assembly satisfies the conditions of 73.82<FOV/CRA<7215.33, the optical lens assembly has a smaller angle at which the chief ray of the maximum viewing angle is incident on the image source plane.

When the optical lens assembly satisfies the conditions of −42.35<R3/f<13.48, the appropriate distribution of the curvature of the second lens is beneficial to correcting the aberration of the optical lens assembly.

When the optical lens assembly satisfies the conditions of 41.99(°)<HFOV*(CA4/CA1)<79.54(°), by using this appropriate configuration, the optical lens assembly has a larger amount of incident light, thereby improving the image quality of the optical lens assembly.

When the optical lens assembly satisfies the conditions of 1.91<TL/BFL<4.60, in this way, a space can be adjusted according to the needs of the mechanism to avoid interference with the appearance of the mechanism, reduce assembly tolerances, and improve the quality of lens products.

When the optical lens assembly satisfies the conditions of 0.77(mm/°)<EPD/CRA<75.60(mm/°), by using this appropriate configuration, the optical lens assembly can have a larger amount of incident light and have a smaller angle at which the chief ray of the maximum viewing angle is incident on the image source plane.

When the optical lens assembly satisfies the conditions of 1.93<TL/f<3.12, in this way, the angle at which the chief ray of the maximum viewing angle is incident on the image source plane can be appropriately controlled.

When the optical lens assembly satisfies the conditions of 2.05<SL/f<3.27, the angle at which the chief ray of the maximum viewing angle is incident on the image source plane can be appropriately provided.

When the optical lens assembly satisfies the conditions of −1.73(mm⁻¹)<1/R1<−0.89(mm⁻¹), the appropriate distribution of the curvature of the first lens is beneficial to correcting the aberration of the optical lens assembly.

When the optical lens assembly satisfies the conditions of 1.12<(CT2/CT1)*(TDP4/TDP1)<6.19, in this way, the spatial adjustability of the optical lens assembly is improved, and lenses of the optical lens assembly have better formability.

### BRIEF DESCRIPTION OF THE DRAWINGS

FIG. 1A is a schematic view of an optical lens assembly according to a first embodiment of the present disclosure.

FIG. 1B sequentially shows a field curvature curve and a distortion curve of an optical lens assembly according to a first embodiment.

FIG. 2A is a schematic view of an optical lens assembly according to a second embodiment of the present disclosure.

FIG. 2B sequentially shows a field curvature curve and a distortion curve of an optical lens assembly according to a second embodiment.

FIG. 3A is a schematic view of an optical lens assembly according to a third embodiment of the present disclosure of the present disclosure.

FIG. 3B shows a field curvature curves and a distortion curve of the optical lens assembly according to the third embodiment.

FIG. 4A is a schematic view of an optical lens assembly according to a fourth embodiment of the present disclosure of the present disclosure.

FIG. 4B shows a field curvature curves and a distortion curve of the optical lens assembly according to the fourth embodiment.

FIG. 5A is a schematic view of an optical lens assembly according to a fifth embodiment of the present disclosure of the present disclosure.

FIG. 5B shows a field curvature curves and a distortion curve of the optical lens assembly according to the fifth embodiment.

FIG. 6A is a schematic view of an optical lens assembly according to a sixth embodiment of the present disclosure of the present disclosure.

FIG. 6B shows a field curvature curves and a distortion curve of the optical lens assembly according to the sixth embodiment.

FIG. 7 is a schematic view of a optical module according to a seventh embodiment of the present disclosure.

### DETAILED DESCRIPTION

In order to enable a person of ordinary skill in the art to understand and realize the contents of the present disclosure, the following are illustrated by proper embodiments with accompanying drawings, and the equivalent substitutions and modifications based on the contents of the present disclosure are included in the scope of the present disclosure. It is also stated that the accompanying drawings of the present disclosure are not depictions of actual dimensions, and although the present disclosure provides embodiments of particular parameters, it is to be understood that the parameters need not be exactly equal to their corresponding values, and that, within an acceptable margin of error, are approximate to their corresponding parameters. The following embodiments will further detail the technical aspects of the present disclosure, but the disclosure is not intended to limit the scope of the present disclosure.

### First Embodiment

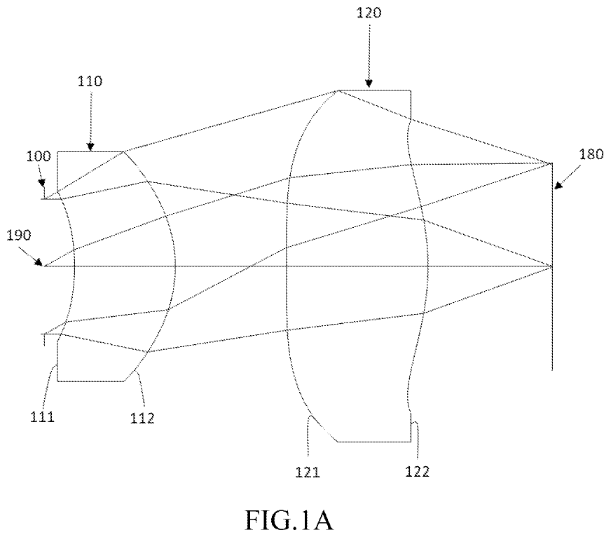

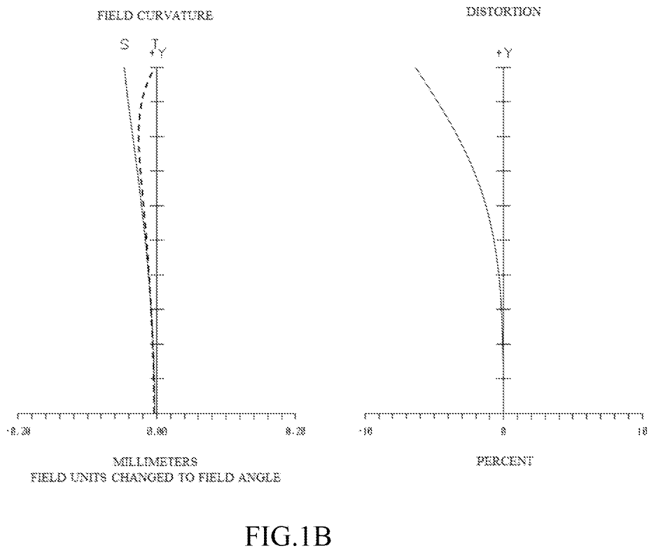

Refer to FIG. 1A and FIG. 1B. FIG. 1A is a schematic view of an optical lens assembly according to a first embodiment of the present disclosure, and FIG. 1B shows a field curvature curve and a distortion curve of an optical lens assembly according to a first embodiment. As can be seen from FIG. 1A, the optical lens assembly includes, in order from an image side to an image source side: a stop 100, a first lens 110, a second lens 120 and an image source plane 180. A total quantity of lenses with refractive power in the optical lens assembly is two.

The first lens 110 with positive refractive power is made of a plastic material and includes an image-side surface 111 and an image-source-side surface 112, wherein the image-side surface 111 of the first lens 110 is concave near an optical axis 190, and the image-source-side surface 112 of the first lens 110 is convex near the optical axis 190. The image-side surface 111 and the image-source-side surface 112 are aspheric.

The second lens 120 with positive refractive power is made of a plastic material and includes an image-side surface 121 and an image-source-side surface 122, wherein the image-side surface 121 of the second lens 120 is concave near the optical axis 190, and the image-source-side surface 122 of the second lens 120 is convex near the optical axis 190. The image-side surface 121 and the image-source-side surface 122 are aspheric.

An aspheric curve equation of the above-mentioned lenses is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein, z is a position value in the direction of the optical axis 190 and with a surface vertex as a reference at a position of a height h; c is a curvature of a lens surface near the optical axis 190, and is a reciprocal of a curvature radius (R) (c=1/R), R is a curvature radius of a lens surface near the optical axis 190, h is a vertical distance between the lens surface and the optical axis 190, k is a conic constant, and Ai is an i^{th} order aspheric coefficient.

In the first embodiment, a focal length of the optical lens assembly is f, an f-number of the optical lens assembly is Fno, and a maximum field of view in the optical lens assembly is FOV, an entrance pupil diameter of the optical lens assembly is EPD, a maximum image source height of the optical lens assembly is IMH, a distance in parallel with the optical axis 190 from an axial point on the image-side surface 111 of the first lens 110 to a maximum optical effective radius position of the image-side surface 111 of the first lens 110 is TDP1, a distance in parallel with the optical axis 190 from an axial point on an image-source-side surface 122 of the second lens 120 to a maximum optical effective radius position of the image-source-side surface 122 of the second lens 120 is TDP4, an incident angle where a chief ray is incident on the image plane at a maximum view angle of the optical lens assembly is CRA, a maximum optical effective radius of an image-side surface 111 of the first lens 110 is CA1, a maximum optical effective radius of an image-source-side surface 122 of the second lens 120 is CA4, a distance from an image-side surface 111 of the first lens 110 to an image source plane 180 along the optical axis 190 is TL, a distance from the image-source-side surface 122 of the second lens 120 to the image source plane 180 along the optical axis 190 is BFL, a distance from the stop 100 to an image source plane 180 along the optical axis 190 is SL, and values are as follows: f=0.91 (mm); Fno=1.62; FOV=53.52(°); EPD=0.56(mm); IMH=0.43(mm); TDP1=0.08(mm); TDP4=0.08(mm); CRA=0.58(°); CA1=0.31(mm); CA4=0.61(mm); TL=2.18(mm); BFL=0.57(mm); SL=2.32(mm).

In the optical lens assembly of the first embodiment, a focal length of the first lens 110 is f1, an entrance pupil diameter of the optical lens assembly is EPD, a maximum image source height of the optical lens assembly is IMH, and the following condition is satisfied: f1/(EPD*IMH)=6.18(mm⁻¹).

In the optical lens assembly of the first embodiment, a curvature radius of an image-side surface 121 of the second lens 120 is R3, a curvature radius of an image-source-side surface 122 of the second lens 120 is R4, and the following condition is satisfied: R3/R4=36.49.

In the optical lens assembly of the first embodiment, a focal length of the optical lens assembly is f, a focal length of the first lens 110 is f1, a focal length of the second lens 120 is f2, and the following condition is satisfied: (f/f1)−(f/f2)=−0.02.

In the optical lens assembly of the first embodiment, a central thickness of the second lens 120 along the optical axis 190 is CT2, a distance from the image-source-side surface 112 of the first lens 110 to the image-side surface 121 of the second lens 120 along the optical axis is T12, and the following condition is satisfied: CT2/T12=1.27.

In the optical lens assembly of the first embodiment, a maximum optical effective radius of an image-source-side surface 122 of the second lens 120 is CA4, a maximum image source height of the optical lens assembly is IMH, an incident angle where a chief ray is incident on the image plane at a maximum view angle of the optical lens assembly is CRA, and the following condition is satisfied: (CA4/IMH)/CRA=2.45(1/°).

In the optical lens assembly of the first embodiment, a maximum field of view of the optical lens assembly is FOV, an incident angle where a chief ray is incident on the image plane at a maximum view angle of the optical lens assembly is CRA, and the following condition is satisfied: FOV/CRA=92.28.

In the optical lens assembly of the first embodiment, a focal length of the optical lens assembly is f, a curvature radius of an image-side surface 121 of the second lens 120 is R3, and the following condition is satisfied: R3/f=−35.30.

In the optical lens assembly of the first embodiment, helf of a maximum field of view of the optical lens assembly is HFOV, a maximum optical effective radius of an image-side surface 111 of the first lens 110 is CA1, a maximum optical effective radius of an image-source-side surface 122 of the second lens 120 is CA4, and the following condition is satisfied: HFOV*(CA4/CA1)=52.49(°).

In the optical lens assembly of the first embodiment, a distance from an image-side surface 111 of the first lens 110 to an image source plane 180 along the optical axis 190 is TL, a distance from the image-source-side surface 122 of the second lens 120 to the image source plane 180 along the optical axis 190 is BFL, and the following condition is satisfied:

$$TL / BFL = 3.83 .$$

In the optical lens assembly of the first embodiment, an incident angle where a chief ray is incident on the image plane at a maximum view angle of the optical lens assembly is CRA, and the following condition is satisfied: EPD/CRA=0.96 (mm/°).

In the optical lens assembly of the first embodiment, a distance from an image-side surface 111 of the first lens 110 to an image source plane 180 along the optical axis 190 is TL, a focal length of the optical lens assembly is f, and the following condition is satisfied:

$$TL / f = 2.41 .$$

In the optical lens assembly of the first embodiment, a distance from the stop 100 to an image source plane 180 along the optical axis 190 is SL, a focal length of the optical lens assembly is f, and the following condition is satisfied: SL/f=2.56.

In the optical lens assembly of the first embodiment, a curvature radius of an image-side surface 111 of the first lens 110 is R1, and the following condition is satisfied:

$$1 / R 1 = - 1.33 ( {mm}^{- 1} ) .$$

In the optical lens assembly of the first embodiment, a central thickness of the first lens 110 along the optical axis 190 is CT1, a central thickness of the second lens 120 along the optical axis 190 is CT2, and the following condition is satisfied:

$$( CT 2 / CT 1 ) * ( TDP 4 / TDP 1 ) = 1.40 .$$

Refer to Table 1 and Table 2 below.

TABLE 1
First embodiment
f (focal length) = 0.91 mm (millimeters), Fno (f-number) = 1.62, FOV (field of view) = 53.52°
(degrees).

| | | Curvature | | Central | | Refractive | Abbe | Focal |
|---|---|---|---|---|---|---|---|---|
| Surface | | radius (mm) | | thickness/gap (mm) | Material | index (nd) | number (vd) | length (mm) |
| 0 | Object | Infinity | | 1000000 | | | | |
| 1 | Stop | Infinity | | 0.139 | | | | |
| 2 | First lens | −0.751 | (ASP) | 0.458 | Plastic | 1.64 | 22.47 | 1.47 |
| 3 | | −0.509 | (ASP) | 0.509 | | | | |
| 4 | Second lens | −31.977 | (ASP) | 0.648 | Plastic | 1.64 | 22.47 | 1.44 |
| 5 | | −0.876 | (ASP) | 0.570 | | | | |
| 6 | Image Source | Infinity | | — | | | | |
| | Plane | | | | | | | |

Reference wavelength 940 nm

TABLE 2
Aspheric coefficient

| Surface | 2 | 3 | 4 | 5 |
|---|---|---|---|---|
| K: | 0.0000E+00 | 0.0000E+00 | 0.0000E+00 | 0.0000E+00 |
| A2: | 0.0000E+00 | 0.0000E+00 | 0.0000E+00 | 0.0000E+00 |
| A4: | −2.6645E+00 | 4.7855E−01 | 1.0435E+00 | 1.0233E+00 |
| A6: | 4.4497E+01 | 4.8336E+00 | −2.8054E−01 | −1.3926E−01 |
| A8: | −5.7072E+02 | −1.7381E+00 | −3.3296E+00 | −1.6101E+00 |
| A10: | 3.0008E+03 | −3.0447E+01 | 1.3925E+01 | 8.9221E+00 |
| A12: | −1.7447E+04 | 3.5560E+02 | −1.9690E+01 | 8.9043E+00 |
| A14: | 3.6494E+05 | −1.6064E+03 | 8.4370E+00 | −8.1651E+00 |
| A16: | −2.2924E+06 | 5.3131E+03 | 2.6887E+00 | −3.2865E+01 |

Table 1 shows detailed configuration data of the first embodiment in FIG. 1A. Units of the curvature radius, the central thickness, the gap, and the focal length is mm. Surfaces 0 to 12 sequentially represent surfaces from an image side to an image source side. Surface 0 is a gap between the projected object and the stop 100. Surface 1 is a gap between the stop 100 and the image-side surface 111 of the first lens 110. The image-side surface 111 of the first lens 110 is closer to the image side than the stop 100, and therefore the stop 100 is represented by a positive value. Otherwise, if the stop 100 is closer to the image side than the image-side surface 111 of the first lens 110, the stop 100 is represented by a negative value. Surfaces 2 and 4 are respectively central thicknesses of the first lens 110 and the second lens 120 along the optical axis 190. Surfaces 3 and 5 respectively are a gap between the first lens 110 and the second lens 120 along the optical axis 190, a gap between the second lens 120 and the image plane 180 along the optical axis 190.

Table 2 shows aspheric data in the first embodiment. k represents a conic constant in an aspheric curve equation, and A2, A4, A6, A8, A10, A12, A14 and A16 are high-order aspheric coefficients. In addition, the following tables of embodiments are schematic diagrams and aberration curves corresponding to the embodiments. The definitions of data in the tables of the embodiments are the same as the definitions in Table 1 and Table 2 of the first embodiment, and are not repeated herein.

### Second Embodiment

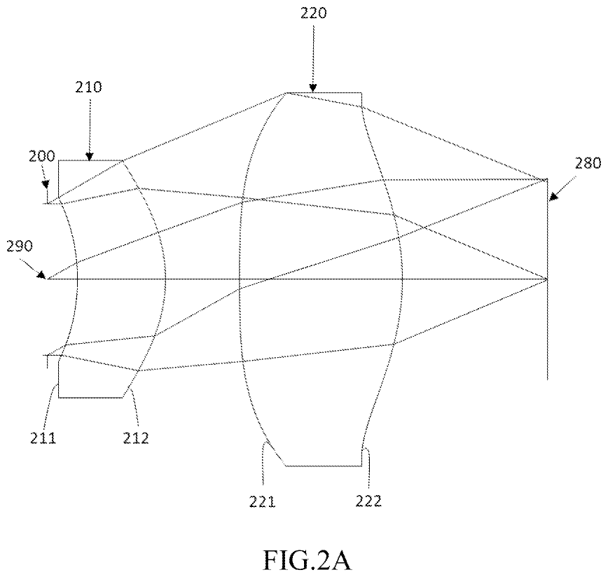

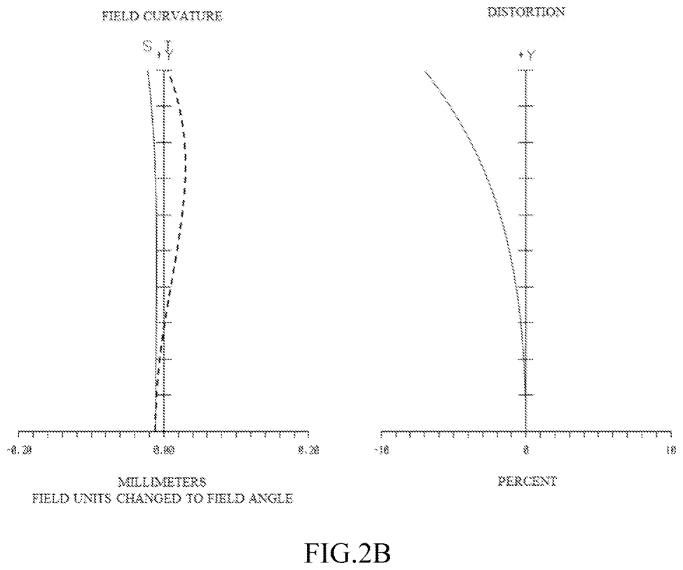

Refer to FIG. 2A and FIG. 2B. FIG. 2A is a schematic view of an optical lens assembly according to a second embodiment of the present disclosure, and FIG. 2B shows a field curvature curve and a distortion curve of an optical lens assembly according to a second embodiment. As can be seen from FIG. 2A, the optical lens assembly includes, in order from an image side to an image source side: a stop 200, a first lens 210, a second lens 220 and an image source plane 280. A total quantity of lenses with refractive power in the optical lens assembly is two.

The first lens 210 with positive refractive power is made of a plastic material and includes an image-side surface 211 and an image-source-side surface 212, wherein the image-side surface 211 of the first lens 210 is concave near an optical axis 290, and the image-source-side surface 212 of the first lens 210 is convex near the optical axis 290. The image-side surface 211 and the image-source-side surface 212 are aspheric.

The second lens 220 with positive refractive power is made of a plastic material and includes an image-side surface 221 and an image-source-side surface 222, wherein the image-side surface 221 of the second lens 220 is convex near the optical axis 290, and the image-source-side surface 222 of the second lens 220 is convex near the optical axis 290. The image-side surface 221 and the image-source-side surface 222 are aspheric.

Refer to Table 3, Table 4 and Table 5 below.

TABLE 3
Second embodiment
f (focal length) = 0.91 mm (millimeters), Fno (f-number) = 1.40, FOV (field of view) = 53.74°
(degrees).

| | | Curvature | | Central | | Refractive | Abbe | Focal |
|---|---|---|---|---|---|---|---|---|
| Surface | | radius (mm) | | thickness/gap (mm) | Material | index (nd) | number (vd) | length (mm) |
| 0 | Object | Infinity | | 1000000 | | | | |
| 1 | Stop | Infinity | | 0.144 | | | | |
| 2 | First lens | −0.745 | (ASP) | 0.419 | Plastic | 1.64 | 22.47 | 1.90 |
| 3 | | −0.555 | (ASP) | 0.351 | | | | |
| 4 | Second lens | 9.163 | (ASP) | 0.773 | Plastic | 1.64 | 22.47 | 1.39 |
| 5 | | −0.919 | (ASP) | 0.690 | | | | |
| 6 | Image Source | Infinity | | — | | | | |
| | Plane | | | | | | | |

Reference wavelength 940 nm

TABLE 4
Aspheric coefficient

| Surface | 2 | 3 | 4 | 5 |
|---|---|---|---|---|
| K: | 6.9713E−01 | −2.3270E−02 | 9.6612E+01 | −2.6824E−02 |
| A2: | 0.0000E+00 | 0.0000E+00 | 0.0000E+00 | 0.0000E+00 |
| A4: | −1.8340E−01 | 1.1035E+00 | 6.5013E−01 | 4.4671E−01 |
| A6: | −2.9988E−01 | −4.3271E−01 | −5.2241E−01 | −5.6571E−02 |
| A8: | 1.2863E+01 | 7.0693E+00 | 2.7315E−01 | 5.9313E−01 |
| A10: | 1.5339E+02 | 2.0985E+01 | 5.4054E−02 | 1.0498E−03 |
| A12: | 1.1716E+02 | −1.9449E−02 | −5.4587E−02 | −1.0786E−02 |
| A14: | −4.0142E+03 | −5.2098E+01 | −8.8965E−03 | 6.8919E−03 |
| A16: | −1.3244E+04 | 2.2988E+00 | 0.0000E+00 | 0.0000E+00 |

In the second embodiment, an aspheric curve equation is expressed as that in the first embodiment. In addition, definitions of parameters in the following tables are the same as those in the first embodiment, and are not repeated herein.

TABLE 5

| EPD | 0.65(mm) | CA1 | 0.35(mm) |
|---|---|---|---|
| IMH | 0.43(mm) | CA4 | 0.74(mm) |
| TDP1 | 0.09(mm) | TL | 2.23(mm) |
| TDP4 | 0.19(mm) | BFL | 0.69(mm) |
| CRA | 0.14(°) | SL | 2.38(mm) |

Referring to Table 3 and Table 5, the following data may be calculated:

Second embodiment

| | | | |
|---|---|---|---|
| f1/(EPD*IMH) | 6.87(mm⁻¹) | HFOV(CA4/CA1) | 56.5(°) |
| R3/R4 | −9.97 | TL/BFL | 3.23 |
| (f/f1)-(f/f2) | −0.18 | EPD/CRA | 4.69(mm/°) |
| CT2/T12 | 2.20 | TL/f | 2.46 |
| (CA4/IMH)/CRA | 12.49(1/°) | SL/f | 2.61 |
| FOV/CRA | 389.40 | 1/R1 | −1.34(mm⁻¹) |
| R3/f | 10.08 | (CT2/CT1)(TDP4/TDP1) | 3.93 |

### Third Embodiment

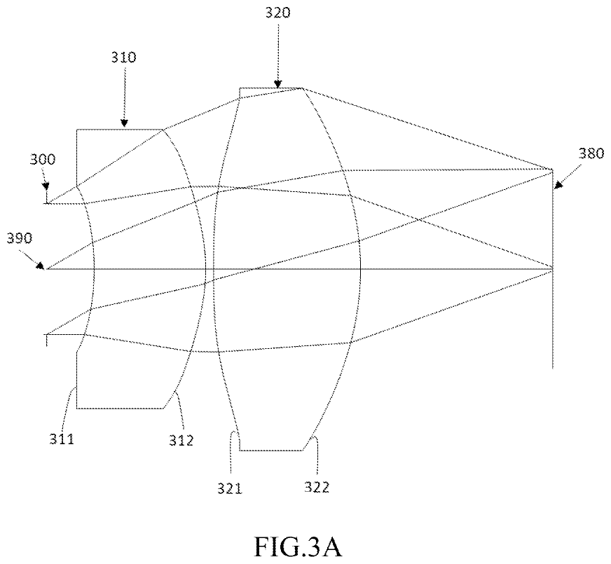

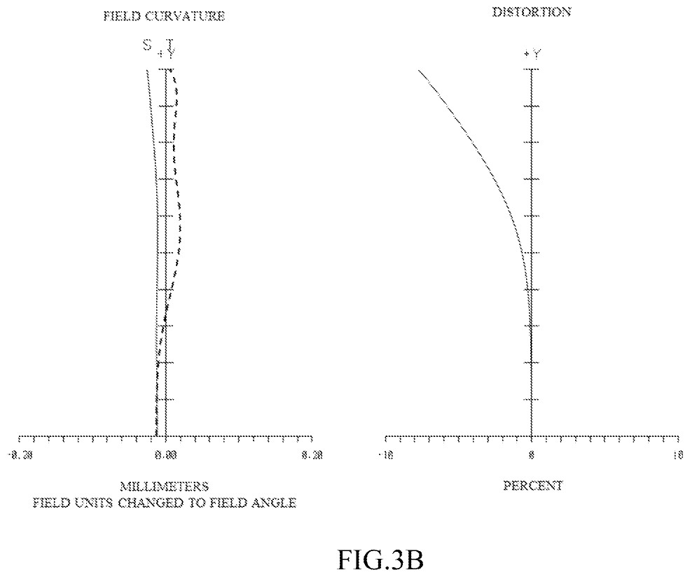

Refer to FIG. 3A and FIG. 3B. FIG. 3A is a schematic view of an optical lens assembly according to a third embodiment of the present disclosure, and FIG. 3B shows a field curvature curve and a distortion curve of an optical lens assembly according to a third embodiment. As can be seen from FIG. 3A, the optical lens assembly includes, in order from an image side to an image source side: a stop 300, a first lens 310, a second lens 320 and an image source plane 380. A total quantity of lenses with refractive power in the optical lens assembly is two.

The first lens 310 with positive refractive power is made of a plastic material and includes an image-side surface 311 and an image-source-side surface 312, wherein the image-side surface 311 of the first lens 310 is concave near an optical axis 390, and the image-source-side surface 312 of the first lens 310 is convex near the optical axis 390. The image-side surface 311 and the image-source-side surface 312 are aspheric.

The second lens 320 with positive refractive power is made of a plastic material and includes an image-side surface 321 and an image-source-side surface 322, wherein the image-side surface 321 of the second lens 320 is convex near the optical axis 390, and the image-source-side surface 322 of the second lens 320 is convex near the optical axis 390. The image-side surface 321 and the image-source-side surface 322 are aspheric.

Refer to Table 6, Table 7 and Table 8 below.

TABLE 6
Third embodiment
f (focal length) = 0.91 mm (millimeters), Fno (f-number) = 1.62, FOV (field of view) = 54.17°
(degrees).

| | | Curvature | | Central | | Refractive | Abbe | Focal |
|---|---|---|---|---|---|---|---|---|
| Surface | | radius (mm) | | thickness/gap (mm) | Material | index (nd) | number (vd) | length (mm) |
| 0 | Object | Infinity | | 1000000 | | | | |
| 1 | Stop | Infinity | | 0.229 | | | | |
| 2 | First lens | −0.899 | (ASP) | 0.537 | Plastic | 1.64 | 22.47 | 2.62 |
| 3 | | −0.711 | (ASP) | 0.040 | | | | |
| 4 | Second lens | 8.807 | (ASP) | 0.708 | Plastic | 1.64 | 22.47 | 1.47 |
| 5 | | −0.987 | (ASP) | 0.927 | | | | |
| 6 | Image Source | Infinity | | — | | | | |
| | Plane | | | | | | | |

Reference wavelength 940 nm

TABLE 7
Aspheric coefficient

| Surface | 2 | 3 | 4 | 5 |
|---|---|---|---|---|
| K: | 2.9405E+00 | −1.2577E−01 | 1.1941E+02 | 4.0110E−02 |
| A2: | 0.0000E+00 | 0.0000E+00 | 0.0000E+00 | 0.0000E+00 |
| A4: | 3.9787E−01 | 1.1978E+00 | 1.6429E+00 | 5.4429E−01 |
| A6: | −1.9057E+01 | 1.9576E+01 | −1.6890E+00 | −2.7225E+00 |
| A8: | 6.4322E+02 | −3.7696E+02 | −8.8074E+01 | 5.2524E+00 |
| A10: | −1.3554E+04 | 3.1136E+03 | 8.9830E+02 | 5.5306E+01 |
| A12: | 2.1122E+05 | −1.3688E+04 | −4.3537E+03 | −3.9533E+02 |
| A14: | −2.1559E+06 | 3.2158E+04 | 1.2014E+04 | 1.1529E+03 |
| A16: | 1.2493E+07 | −3.6054E+04 | −1.9300E+04 | −1.7708E+03 |
| A18: | −3.6788E+07 | 1.0832E+04 | 1.6865E+04 | 1.4081E+03 |
| A20: | 4.2696E+07 | 5.6534E+03 | −6.2185E+03 | −4.5771E+02 |

Table 7 shows aspheric data in the third embodiment. k represents a conic constant in an aspheric curve equation, and A2, A4, A6, A8, A10, A12, A14, A16, A18 and A20 are high-order aspheric coefficients. In addition, definitions of parameters in the following tables are the same as those in the first embodiment, and are not repeated herein.

TABLE 8

| EPD | 0.56(mm) | CA1 | 0.35(mm) |
|---|---|---|---|
| IMH | 0.43(mm) | CA4 | 0.78(mm) |
| TDP1 | 0.09(mm) | TL | 2.21(mm) |
| TDP4 | 0.28(mm) | BFL | 0.93(mm) |
| CRA | 0.39(°) | SL | 2.44(mm) |

Referring to Table 6 and Table 8, the following data may be calculated:

Third embodiment

| | | | |
|---|---|---|---|
| f1/(EPD*IMH) | 10.93(mm⁻¹) | HFOV(CA4/CA1) | 59.39(°) |
| R3/R4 | −8.93 | TL/BFL | 2.39 |
| (f/f1)-(f/f2) | −0.27 | EPD/CRA | 1.44(mm/°) |
| CT2/T12 | 17.52 | TL/f | 2.44 |
| (CA4/IMH)/CRA | 4.67(1/°) | SL/f | 2.69 |
| FOV/CRA | 139.61 | 1/R1 | −1.11(mm⁻¹) |
| R3/f | 9.71 | (CT2/CT1)(TDP4/TDP1) | 4.36 |

### Fourth Embodiment

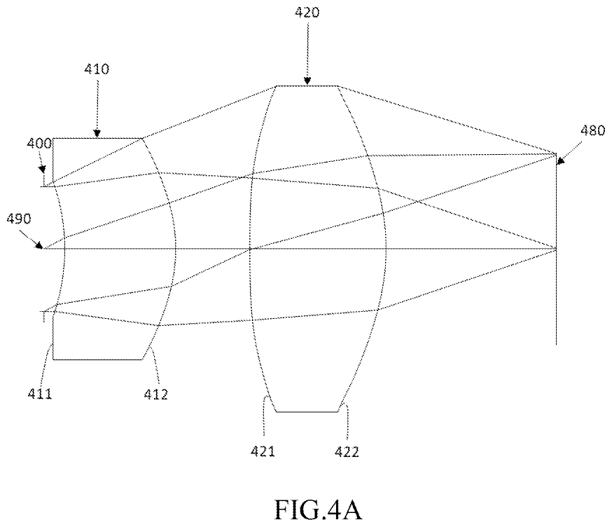

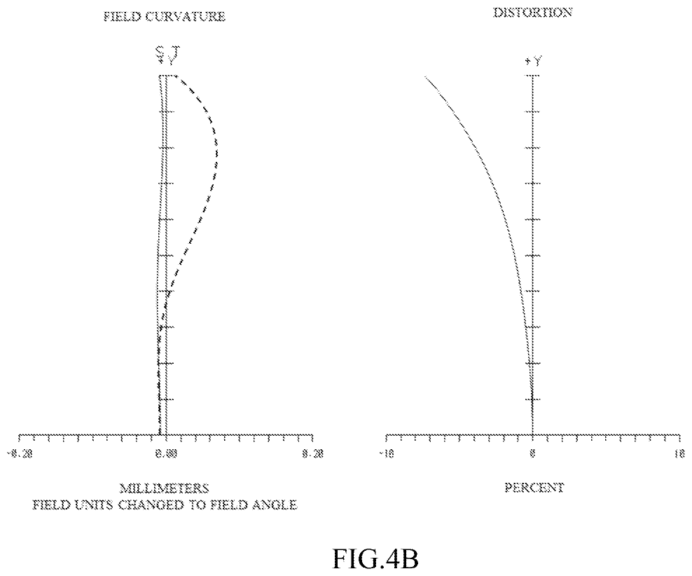

Refer to FIG. 4A and FIG. 4B. FIG. 4A is a schematic view of an optical lens assembly according to a fourth embodiment of the present disclosure, and FIG. 4B shows a field curvature curve and a distortion curve of an optical lens assembly according to a fourth embodiment. As can be seen from FIG. 4A, the optical lens assembly includes, in order from an image side to an image source side: a stop 400, a first lens 410, a second lens 420 and an image source plane 480. A total quantity of lenses with refractive power in the optical lens assembly is two.

The first lens 410 with positive refractive power is made of a plastic material and includes an image-side surface 411 and an image-source-side surface 412, wherein the image-side surface 411 of the first lens 410 is concave near an optical axis 490, and the image-source-side surface 412 of the first lens 410 is convex near the optical axis 490. The image-side surface 411 and the image-source-side surface 412 are aspheric.

The second lens 420 with positive refractive power is made of a plastic material and includes an image-side surface 421 and an image-source-side surface 422, wherein the image-side surface 421 of the second lens 420 is convex near the optical axis 490, and the image-source-side surface 422 of the second lens 420 is convex near the optical axis 490. The image-side surface 421 and the image-source-side surface 422 are aspheric.

Refer to Table 9, Table 10 and Table 11 below.

TABLE 9
Fourth embodiment
f (focal length) = 0.91 mm (millimeters), Fno (f-number) = 1.62, FOV (field of view) = 53.85°
(degrees).

| | | Curvature | | Central | | Refractive | Abbe | Focal |
|---|---|---|---|---|---|---|---|---|
| Surface | | radius (mm) | | thickness/gap (mm) | Material | index (nd) | number (vd) | length (mm) |
| 0 | Object | Infinity | | 1000000 | | | | |
| 1 | Stop | Infinity | | 0.098 | | | | |
| 2 | First lens | −0.860 | (ASP) | 0.526 | Plastic | 1.64 | 22.47 | 2.32 |
| 3 | | −0.665 | (ASP) | 0.350 | | | | |
| 4 | Second lens | 8.357 | (ASP) | 0.646 | Plastic | 1.64 | 22.47 | 1.38 |

| 5 | | −0.929 | (ASP) | 0.808 |
|---|---|---|---|---|
| 6 | Image Source | Infinity | | — |
| | Plane | | | |

Reference wavelength 940 nm

TABLE 10
Aspheric coefficient

| Surface | 2 | 3 | 4 | 5 |
|---|---|---|---|---|
| K: | 8.0886E−01 | −2.7552E−02 | 1.1409E+02 | −8.6354E−03 |
| A2: | 0.0000E+00 | 0.0000E+00 | 0.0000E+00 | 0.0000E+00 |
| A4: | 2.2657E+00 | 3.8578E−01 | 7.1873E−01 | 5.3365E−01 |
| A6: | −1.2863E+02 | 3.8092E+01 | −2.3332E+00 | −3.7902E−01 |
| A8: | 3.6875E+03 | −8.1753E+02 | 9.5240E+00 | −8.4382E+00 |
| A10: | −5.8161E+04 | 8.5124E+03 | −1.1892E+01 | 8.3068E+01 |
| A12: | 5.2979E+05 | −4.6327E+04 | −5.6911E+01 | −2.9249E+02 |
| A14: | −2.6221E+06 | 1.2662E+05 | 1.7572E+02 | 4.4981E+02 |
| A16: | 5.3532E+06 | −1.3717E+05 | −1.3386E+02 | −2.5352E+02 |
| A18: | 0.0000E+00 | 0.0000E+00 | 0.0000E+00 | 0.0000E+00 |
| A20: | 0.0000E+00 | 0.0000E+00 | 0.0000E+00 | 0.0000E+00 |

In the Fourth embodiment, an aspheric curve equation is expressed as that in the third embodiment. In addition, definitions of parameters in the following tables are the same as those in the first embodiment, and are not repeated herein.

TABLE 11

| EPD | 0.56(mm) | CA1 | 0.30(mm) |
|---|---|---|---|
| IMH | 0.43(mm) | CA4 | 0.73(mm) |
| TDP1 | 0.05(mm) | TL | 2.33(mm) |
| TDP4 | 0.23(mm) | BFL | 0.81(mm) |
| CRA | 0.52(°) | SL | 2.43(mm) |

Referring to Table 9 and Table 11, the following data may be calculated:

Fourth embodiment

| | | | |
|---|---|---|---|
| f1/(EPD*IMH) | 9.66(mm⁻¹) | HFOV(CA4/CA1) | 65.13(°) |
| R3/R4 | −9.00 | TL/BFL | 2.88 |
| f/f1)-(f/f2) | −0.27 | EPD/CRA | 1.07(mm/°) |
| CT2/T12 | 1.84 | TL/f | 2.56 |
| (CA4/IMH)/CRA | 3.27(1/°) | SL/f | 2.67 |
| FOV/CRA | 102.77 | 1/R1 | −1.16(mm⁻¹) |
| R3/f | 9.19 | (CT2/CT1)(TDP4/TDP1) | 5.16 |

### Fifth Embodiment

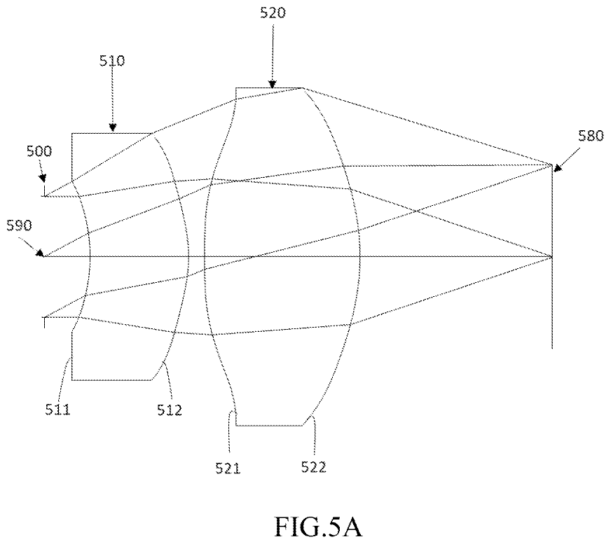

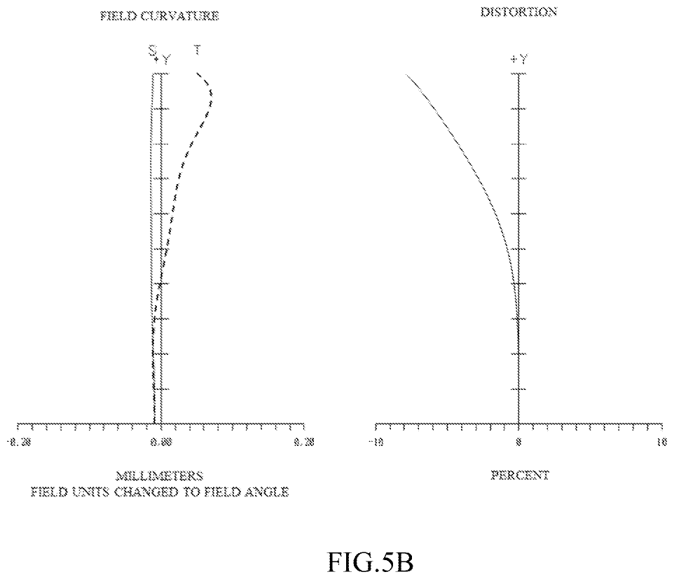

Refer to FIG. 5A and FIG. 5B. FIG. 5A is a schematic view of an optical lens assembly according to a fifth embodiment of the present disclosure, and FIG. 5B shows a field curvature curve and a distortion curve of an optical lens assembly according to a fifth embodiment. As can be seen from FIG. 5A, the optical lens assembly includes, in order from an image side to an image source side: a stop 500, a first lens 510, a second lens 520 and an image source plane 580. A total quantity of lenses with refractive power in the optical lens assembly is two.

The first lens 510 with positive refractive power is made of a plastic material and includes an image-side surface 511 and an image-source-side surface 512, wherein the image-side surface 511 of the first lens 510 is concave near an optical axis 590, and the image-source-side surface 512 of the first lens 510 is convex near the optical axis 590. The image-side surface 511 and the image-source-side surface 512 are aspheric.

The second lens 520 with positive refractive power is made of a plastic material and includes an image-side surface 521 and an image-source-side surface 522, wherein the image-side surface 521 of the second lens 520 is convex near the optical axis 490, and the image-source-side surface 522 of the second lens 520 is convex near the optical axis 590. The image-side surface 521 and the image-source-side surface 522 are aspheric.

Refer to Table 12, Table 13 and Table 14 below.

TABLE 12
Fifth embodiment
f (focal length) = 0.91 mm (millimeters), Fno (f-number) = 1.62, FOV (field of view) = 54.23°
(degrees).

| | | Curvature | | Central | | Refractive | Abbe | Focal |
|---|---|---|---|---|---|---|---|---|
| Surface | | radius (mm) | | thickness/gap (mm) | Material | index (nd) | number (vd) | length (mm) |
| 0 | Object | Infinity | | 1000000 | | | | |
| 1 | Stop | Infinity | | 0.221 | | | | |
| 2 | First lens | −0.693 | (ASP) | 0.481 | Plastic | 1.64 | 22.47 | 2.71 |
| 3 | | −0.622 | (ASP) | 0.077 | | | | |
| 4 | Second lens | 8.409 | (ASP) | 0.758 | Plastic | 1.64 | 22.47 | 1.47 |
| 5 | | −0.988 | (ASP) | 0.936 | | | | |
| 6 | Image Source | Infinity | | — | | | | |
| | Plane | | | | | | | |

Reference wavelength 940 nm

TABLE 13
Aspheric coefficient

| Surface | 2 | 3 | 4 | 5 |
|---|---|---|---|---|
| K: | 1.5626E+00 | −4.4437E−01 | 1.2190E+02 | 1.5492E−02 |
| A2: | 0.0000E+00 | 0.0000E+00 | 0.0000E+00 | 0.0000E+00 |
| A4: | 5.7857E+00 | 2.7111E+00 | 2.9712E+00 | 6.4175E−01 |
| A6: | −5.0351E+02 | 2.2917E+01 | −8.7533E+00 | −3.4406E+00 |
| A8: | 2.6569E+04 | −5.7840E+02 | −7.2011E+01 | 1.8279E+01 |
| A10: | −7.8188E+05 | 5.2848E+03 | 9.3002E+02 | −2.0709E+01 |
| A12: | 1.3847E+07 | −2.6144E+04 | −4.7946E+03 | −1.6878E+02 |
| A14: | −1.5074E+08 | 7.1818E+04 | 1.3877E+04 | 7.5971E+02 |
| A16: | 9.8518E+08 | −1.0147E+05 | −2.3515E+04 | −1.3927E+03 |
| A18: | −3.5380E+09 | 5.5233E+04 | 2.1822E+04 | 1.2443E+03 |
| A20: | 5.3499E+09 | 3.0951E+03 | −8.5690E+03 | −4.4363E+02 |

In the Fifth embodiment, an aspheric curve equation is expressed as that in the third embodiment. In addition, definitions of parameters in the following tables are the same as those in the first embodiment, and are not repeated herein.

TABLE 14

| EPD | 0.56(mm) | CA1 | 0.35(mm) |
|---|---|---|---|
| IMH | 0.43(mm) | CA4 | 0.78(mm) |
| TDP1 | 0.09(mm) | TL | 2.25(mm) |
| TDP4 | 0.28(mm) | BFL | 0.94(mm) |
| CRA | 0.32(°) | SL | 2.47(mm) |

Referring to Table 12 and Table 14, the following data may be calculated:

Fifth embodiment

| | | | |
|---|---|---|---|
| f1/(EPD*IMH) | 11.31(mm⁻¹) | HFOV(CA4/CA1) | 61.13(°) |
| R3/R4 | −8.51 | TL/BFL | 2.41 |
| (f/f1)-(f/f2) | −0.28 | EPD/CRA | 1.77(mm/°) |
| CT2/T12 | 9.78 | TL/f | 2.48 |
| (CA4/IMH)/CRA | 5.77(1/°) | SL/f | 2.73 |
| FOV/CRA | 171.08 | 1/R1 | −1.44(mm⁻¹) |
| R3/f | 9.27 | (CT2/CT1)(TDP4/TDP1) | 4.98 |

### Sixth Embodiment

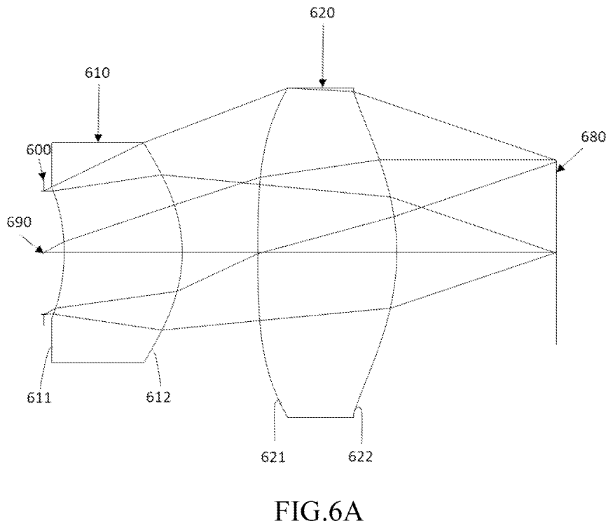

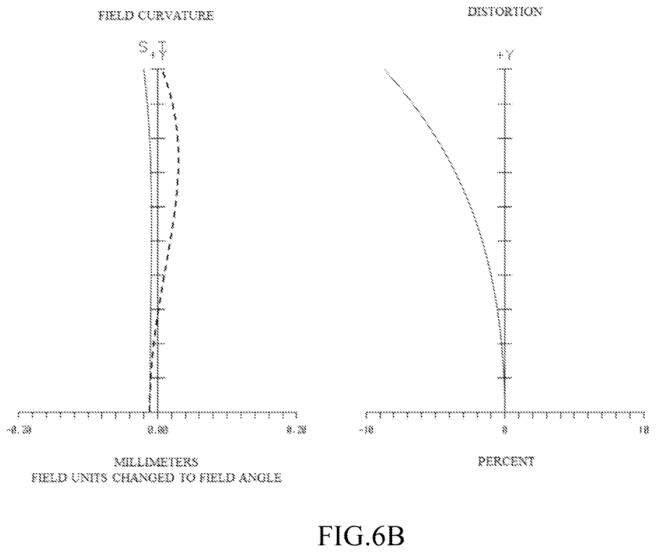

Refer to FIG. 6A and FIG. 6B. FIG. 6A is a schematic view of an optical lens assembly according to a sixth embodiment of the present disclosure, and FIG. 6B shows a field curvature curve and a distortion curve of an optical lens assembly according to a sixth embodiment. As can be seen from FIG. 6A, the optical lens assembly includes, in order from an image side to an image source side: a stop 600, a first lens 610, a second lens 620 and an image source plane 680. A total quantity of lenses with refractive power in the optical lens assembly is two.

The first lens 610 with positive refractive power is made of a plastic material and includes an image-side surface 611 and an image-source-side surface 612, wherein the image-side surface 611 of the first lens 610 is concave near an optical axis 690, and the image-source-side surface 512 of the first lens 610 is convex near the optical axis 690. The image-side surface 611 and the image-source-side surface 612 are aspheric.

The second lens 620 with positive refractive power is made of a plastic material and includes an image-side surface 621 and an image-source-side surface 622, wherein the image-side surface 621 of the second lens 620 is convex near the optical axis 490, and the image-source-side surface 622 of the second lens 620 is convex near the optical axis 690. The image-side surface 621 and the image-source-side surface 622 are aspheric.

Refer to Table 15, Table 16 and Table 17 below.

TABLE 15
Sixth embodiment
f (focal length) = 0.92 mm (millimeters), Fno (f-number) = 1.62, FOV (field of view) = 54.11°
(degrees).

| | | Curvature | | Central | | Refractive | Abbe | Focal |
|---|---|---|---|---|---|---|---|---|
| Surface | | radius (mm) | | thickness/gap (mm) | Material | index (nd) | number (vd) | length (mm) |
| 0 | Object | Infinity | | 1000000 | | | | |
| 1 | Stop | Infinity | | 0.097 | | | | |
| 2 | First lens | −0.840 | (ASP) | 0.573 | Plastic | 1.64 | 22.47 | 1.94 |
| 3 | | −0.624 | (ASP) | 0.367 | | | | |
| 4 | Second lens | 10.316 | (ASP) | 0.675 | Plastic | 1.64 | 22.47 | 1.52 |
| 5 | | −1.013 | (ASP) | 0.773 | | | | |
| 6 | Image Source | Infinity | | — | | | | |
| | Plane | | | | | | | |

Reference wavelength 940 nm

TABLE 16
Aspheric coefficient

| Surface | 2 | 3 | 4 | 5 |
|---|---|---|---|---|
| K | 8.4362E−01 | −3.0308E−02 | 1.3769E+02 | −1.0560E−02 |
| A2: | 0.0000E+00 | 0.0000E+00 | 0.0000E+00 | 0.0000E+00 |
| A4: | −1.0710E−01 | 7.9363E−01 | 4.6188E−01 | 3.0133E−01 |
| A6: | −2.8403E−01 | −1.3148E−01 | −2.8910E−01 | −4.5361E−02 |
| A8: | 1.6332E+00 | 3.6148E+00 | 1.0850E−01 | 3.0504E−01 |
| A10: | −1.6782E+01 | 8.4371E+00 | −2.5743E−02 | 2.7606E−04 |
| A12: | −3.0885E+02 | −7.6922E−02 | 7.5348E−03 | 7.8782E−03 |
| A14: | −1.1046E+04 | −4.6953E+01 | −2.3913E−03 | 1.1458E−03 |
| A16: | 3.4059E+05 | −3.8954E−04 | 0.0000E+00 | 0.0000E+00 |

In the sixth embodiment, an aspheric curve equation is expressed as that in the first embodiment. In addition, definitions of parameters in the following tables are the same as those in the first embodiment, and are not repeated herein.

TABLE 17

| EPD | 0.57(mm) | CA1 | 0.30(mm) |
|---|---|---|---|
| IMH | 0.43(mm) | CA4 | 0.74(mm) |
| TDP1 | 0.06(mm) | TL | 2.39(mm) |
| TDP4 | 0.21(mm) | BFL | 0.77(mm) |
| CRA | 0.01(°) | SL | 2.49(mm) |

Referring to Table 15 and Table 17, the following data may be calculated:

Sixth embodiment

| | | | |
|---|---|---|---|
| f1/(EPD*IMH) | 7.99(mm⁻¹) | HFOV(CA4/CA1) | 66.28(°) |
| R3/R4 | −10.19 | TL/BFL | 3.09 |
| (f/f1)-(f/f2) | −0.13 | EPD/CRA | 63(mm/°) |
| CT2/T12 | 1.84 | TL/f | 2.60 |
| (CA4/IMH)/CRA | 192.54(1/°) | SL/f | 2.71 |
| FOV/CRA | 6012.78 | 1/R1 | −1.19(mm⁻¹) |
| R3/f | 11.24 | (CT2/CT1)(TDP4/TDP1) | 4.24 |

### Seventh Embodiment

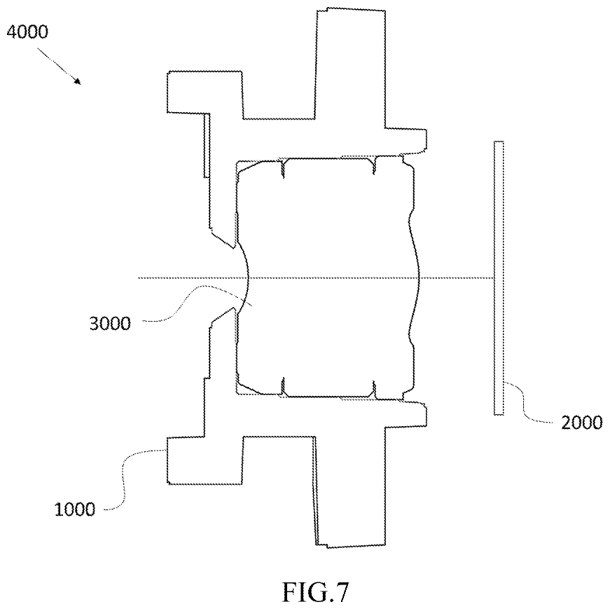

Refer to FIG. 7. FIG. 7 is a schematic view of an optical module according to a seventh embodiment of the present disclosure. The optical module 4000 includes a lens barrel 1000, an optical lens assembly 3000, and a light source 2000. The optical lens assembly 3000 can be the optical lens assemblies according to the above-mentioned embodiments, and the optical lens assembly 3000 is disposed in the lens barrel 1000. The light source 2000 is disposed on an image source plane of the optical lens assembly 3000.

In the foregoing embodiments, those with ordinary knowledge in the art should understand that, in the optical lens assembly and the optical module provided in the present disclosure, the lens may be made of glass or plastic. The lens made of glass can increase the degree of freedom of the configuration of the refractive power of the optical lens assembly. The lens made of glass may be made by using related technologies such as grinding, molding, or the like. The lens made of plastic can reduce the production costs.

In the optical lens assembly provided in the present disclosure, for the lens with refractive power, if the surface of the lens is convex and a position of the convex surface is not defined, it indicates that the surface of the lens is convex near the optical axis. If the surface of the lens is concave and a position of the concave surface is not defined, it indicates that the surface of the lens is concave near the optical axis.

The optical lens assembly provided by the present disclosure can be used in moving focus optical systems according to the needs, and has the characteristics of excellent aberration correction and good imaging quality, and can be used in various aspects such as 3D (three-dimensional) image capture, digital cameras, and electronic imaging systems such as mobile devices, digital tablets or car photography, but not limited thereto.

What is claimed is:

1. An optical lens assembly comprising a stop, and in order from an image side to an image source side, comprising:
a first lens with positive refractive power, comprising an image-side surface and an image-source-side surface, wherein the image-side surface of the first lens is concave near the optical axis; and
a second lens with positive refractive power, comprising an image-side surface and an image-source-side surface, wherein the image-source-side surface of the second lens is convex near the optical axis;
wherein a total quantity of lenses with refractive power in the optical lens assembly is two, a focal length of the first lens is f1, an entrance pupil diameter of the optical lens assembly is EPD, a maximum image source height of the optical lens assembly is IMH, and the following condition is satisfied: 4.94(mm⁻¹)<f1/(EPD*IMH)<13.57(mm⁻¹).

2. The optical lens assembly according to claim 1, wherein a curvature radius of an image-side surface of the second lens is R3, a curvature radius of an image-source-side surface of the second lens is R4, and the following condition is satisfied: −12.22<R3/R4<43.78.

3. The optical lens assembly according to claim 1, wherein a focal length of the optical lens assembly is f, a focal length of the second lens is f2, and the following condition is satisfied: −0.34<(f/f1)−(f/f2)<−0.01.

4. The optical lens assembly according to claim 1, wherein a central thickness of the second lens along the optical axis is CT2, a distance from the image-source-side surface of the first lens to the image-side surface of the second lens along the optical axis is T12, and the following condition is satisfied: 1.02<CT2/T12<21.02.

5. The optical lens assembly according to claim 1, wherein a maximum optical effective radius of an image-source-side surface of the second lens is CA4, an incident angle where a chief ray is incident on the image plane at a maximum view angle of the optical lens assembly is CRA, and the following condition is satisfied: 1.96(1/°)<(CA4/IMH)/CRA<231.05(1/°).

6. The optical lens assembly according to claim 1, wherein a maximum field of view of the optical lens assembly is FOV, an incident angle where a chief ray is incident on the image plane at a maximum view angle of the optical lens assembly is CRA, and the following condition is satisfied: 73.82<FOV/CRA<7215.33.

7. The optical lens assembly according to claim 1, wherein a focal length of the optical lens assembly is f, a curvature radius of an image-side surface of the second lens is R3, and the following condition is satisfied: −42.35<R3/f<13.48.

8. The optical lens assembly according to claim 1, wherein helf of a maximum field of view of the optical lens assembly is HFOV, a maximum optical effective radius of an image-side surface of the first lens is CA1, a maximum optical effective radius of an image-source-side surface of the second lens is CA4, and the following condition is satisfied:
$$41.99 {(}^{°} ) < HFOV * ( CA 4 / CA 1 ) < 79.54 {(}^{°} ) .$$

9. The optical lens assembly according to claim 1, wherein a distance from an image-side surface of the first lens to an image source plane along the optical axis is TL, a distance from the image-source-side surface of the second lens to the image source plane along the optical axis is BFL, and the following condition is satisfied: 1.91<TL/BFL<4.60.

10. The optical lens assembly according to claim 1, wherein an incident angle where a chief ray is incident on the image plane at a maximum view angle of the optical lens assembly is CRA, and the following condition is satisfied: 0.77(mm/°)<EPD/CRA<75.60(mm/°).

11. The optical lens assembly according to claim 1, wherein a distance from an image-side surface of the first lens to an image source plane along the optical axis is TL, a focal length of the optical lens assembly is f, and the following condition is satisfied: 1.93<TL/f<3.12.

12. The optical lens assembly according to claim 1, wherein a distance from the stop to an image source plane along the optical axis is SL, a focal length of the optical lens assembly is f, and the following condition is satisfied: 2.05<SL/f<3.27.

13. The optical lens assembly according to claim 1, wherein a curvature radius of an image-side surface of the first lens is R1, and the following condition is satisfied: −1.73(mm⁻¹)<1/R1<−0.89(mm⁻¹).

14. The optical lens assembly according to claim 1, wherein a central thickness of the first lens along the optical axis is CT1, a central thickness of the second lens along the optical axis is CT2, a distance in parallel with the optical axis from an axial point on the image-side surface of the first lens to a maximum optical effective radius position of the image-side surface of the first lens is TDP1, a distance in parallel with the optical axis from an axial point on an image-source-side surface of the second lens to a maximum optical effective radius position of the image-source-side surface of the second lens is TDP4, and the following condition is satisfied: 1.12<(CT2/CT1)*(TDP4/TDP1)<6.19.

15. An optical module, comprising:
a lens barrel;
an optical lens assembly disposed in the lens barrel; and
a light source disposed on an image source plane of the optical lens assembly;
wherein the optical lens assembly comprising a stop, and in order from an image side to an image source side, comprising:
a first lens with positive refractive power, comprising an image-side surface and an image-source-side surface, wherein the image-side surface of the first lens is concave near the optical axis; and
a second lens with positive refractive power, comprising an image-side surface and an image-source-side surface, wherein the image-source-side surface of the second lens is convex near the optical axis;
wherein a total quantity of lenses with refractive power in the optical lens assembly is two, a focal length of the first lens is f1, an entrance pupil diameter of the optical lens assembly is EPD, a maximum image source height of the optical lens assembly is IMH, and the following condition is satisfied: 4.94(mm⁻¹)<f1/(EPD*IMH)<13.57(mm⁻¹).

16. The optical module according to claim 15, wherein a curvature radius of an image-side surface of the second lens is R3, a curvature radius of an image-source-side surface of the second lens is R4, and the following condition is satisfied: −12.22<R3/R4<43.78.

17. The optical module according to claim 15, wherein a central thickness of the second lens along the optical axis is CT2, a distance from the image-source-side surface of the first lens to the image-side surface of the second lens along the optical axis is T12, and the following condition is satisfied: 1.02<CT2/T12<21.02.

18. The optical module according to claim 15, wherein a maximum field of view of the optical lens assembly is FOV, an incident angle where a chief ray is incident on the image plane at a maximum view angle of the optical lens assembly is CRA, and the following condition is satisfied: 73.82<FOV/CRA<7215.33.

19. The optical module according to claim 15, wherein a focal length of the optical lens assembly is f, a curvature radius of an image-side surface of the second lens is R3, and the following condition is satisfied: −42.35<R3/f<13.48.

20. The optical module according to claim 15, wherein an incident angle where a chief ray is incident on the image plane at a maximum view angle of the optical lens assembly is
$$0.77 ( mm {/}^{°} ) < EPD / CRA < 75.60 ( mm {/}^{°} ) .$$
